(19) United States
(12) Patent Application Publication
(10) Pub. No.: US 2026/0339851 A1
(43) Pub. Date: Oct. 29, 2026

(54) DEVICE COMPRISING MEMORY CONTROLLER

(71) Applicant: Renesas Design Netherlands B.V., 's-Hertogenbosch (NL)

(72) Inventors: Itzhak Dov HIRSHFELD, Givat Shmuel (IL); Yoni KAHANA, Ein Sarid (IL)

(73) Assignee: Renesas Design Netherlands B.V., 's-Hertogenbosch (NL)

(21) Appl. No.: 19/188,602

(22) Filed: Apr. 24, 2025

(51) Int. Cl. G06F 12/14; G06F 21/57; H04L 9/08

(52) U.S. Cl. CPC G06F 12/1408; G06F 21/575; H04L 9/085; G06F 2221/034

(57) ABSTRACT

A device including a processor and a memory controller configured to encrypt a firmware image using a device key. The processor is configured to provide the device key to the memory controller. The firmware image includes a plurality of firmware sections. The memory controller is configured to encrypt the firmware image using the device key by: for each of the plurality of firmware sections, retrieving the firmware section, decrypting the firmware section using a shared key, encrypting the firmware section using the device key, and storing the firmware section as encrypted by the device key in a memory array.

### FIELD

The present disclosure relates to a device comprising a memory controller. In particular, the present disclosure relates to a device comprising a memory controller for encrypting a firmware image.

### BACKGROUND

Wireless devices running firmware often need to be updated to improved versions of the firmware, for example to address security vulnerabilities or improve the functionality and performance of the wireless device. Such devices exist in many areas of technology including in the automative and internet of things (IoT) domains.

Although it is possible to update each device via a wired interface, which ensures some level of security, there are many benefits in updating the firmware in a wireless manner.

Firmware update over-the-air (FOTA) is conventionally protected using the following two types of cryptographic process:
1. Asymmetric encryption for authentication and integrity
The creator/distributor of the firmware has a public and a private key. The public key is distributed to all devices that may need to receive a firmware update. The distributor signs the firmware image using the private key. Anyone with access to the public key may then verify the signed image and retrieve the firmware image.
Thanks to cryptographic signing, a receiving device is able to verify the integrity of the received image and confirm that it was sent from a legitimate source (i.e. the image's authenticity). Thus, an adversary cannot manipulate the image to compromise the receiving device.
2. Symmetric encryption for confidentiality.
The creator/distributor of the firmware has a shared key, labelled as such because it is also shared with all devices that may receive a firmware update. The distributor encrypts the firmware image using the shared key. Anyone with knowledge of the shared key may decrypt the encrypted image and retrieve the firmware image.
By encrypting the firmware image even if a malicious user obtains the encrypted image, they would be unable to retrieve its contents without access to the distributor's public key.

A firmware image refers to a file including the firmware code for running the firmware on a device. A device's firmware includes instructions for the operating of the device.

Some systems may use only one of the above methods, depending on the security requirements of the system. For example, some systems may use authentication as described above, but omit encrypting the firmware itself, if the image itself is not considered as confidential. In other cases, the image is also encrypted with the symmetric key as described above and the keys are provisioned or shared in a secure manner to all the devices that are intended to receive the update.

Using the same shared key across multiple devices can be a security vulnerability. For example, in the case of an accidental or malicious exposure of the shared key for any reason (such as leaking of the key by the distributor, an insider leak, leaking of the key from a specific device that has been compromised) the image stored in all of the devices that use the same shared key would be exposed, thereby compromising the confidentiality of the firmware image. Moreover, an adversary in this case may be able to inject code to targeted device, even if the code is encrypted. (e.g. in case of execution in place).

To reduce the likelihood of a shared key being leaked, robust security is implemented on the distributor side. The key is stored very securely, and since it is on the server side there are no hardware constraints that may reduce the robustness of the security measures used to protect the shared key. As such, it is more likely that the key will be exposed through the edge device itself, i.e. the device that would receive the firmware image from the distributor.

One way to address this problem is via a key replacement method that takes place on the receiving device. During key replacement, the receiving device uses the shared key to decrypt the new firmware image (which may have been received via FOTA or via other means) and re-encrypts the image with a device-unique key.

### SUMMARY

It is desirable to provide an improved system for encryption and/or decryption of firmware. In particular, it is desirable to provide an improvement system for key replacement as part of a firmware update process.

According to a first aspect of the disclosure there is provided a device comprising a processor, and a memory controller configured to encrypt a firmware image using a device key.

Optionally, the processor is configured to provide the device key to the memory controller.

Optionally, the device key is a symmetric key or an asymmetric key.

Optionally, the firmware image comprises a plurality of firmware sections, and the memory controller is configured to encrypt the firmware image using the device key by, for each of the plurality of firmware sections, retrieving the firmware section, decrypting the firmware section using a shared key, encrypting the firmware section using the device key, and storing the firmware section as encrypted by the device key in a memory array.

Optionally, prior to encryption of the firmware image using the device key by the memory controller, the plurality of firmware sections are stored in the memory array, and the memory controller is configured to encrypt the firmware image using the device key by, for each of the plurality of firmware sections, retrieving the firmware section from the memory array, decrypting the firmware section using the shared key, encrypting the firmware section using the device key, and storing the firmware section as encrypted by the device key in the memory array.

Optionally, the memory controller is configured to, for each of the plurality of firmware sections, store the firmware section as encrypted by the device key in the memory array by overwriting the firmware section encrypted using the shared key as retrieved from the memory array.

Optionally, the processor is configured to provide the shared key to the memory controller.

Optionally, the processor is configured to perform a hash function on each of the decrypted firmware sections to generate a hashed section for each of the decrypted firmware sections.

Optionally, for each of the decrypted firmware sections the processor is configured to perform the hash function on the decrypted firmware section in parallel to the memory controller encrypting the firmware section using the device key and/or storing the firmware section as encrypted by the device key in the memory array.

Optionally, the processor is configured to perform the hash function on each of the decrypted firmware sections by, for each of the decrypted firmware sections, requesting the decrypted firmware section from the memory controller, receiving the decrypted firmware section from the memory controller, and performing the hash function on the decrypted firmware section, as received.

Optionally, the processor is configured to store the hashed sections in a hash memory element.

Optionally, the processor is configured to generate a hash file by combining the hashed sections.

Optionally, the memory controller is configured to decrypt a signing section, and provide the decrypted signing section to the processor, and the processor is configured to authenticate the firmware image by verifying the decrypted signing section using a public key, and comparing the decrypted signing section with the hash file.

Optionally, the memory controller is configured to decrypt the signing section and provide the decrypted signing section to the processor, in response to a request from the processor.

Optionally, the device is configured to discard the firmware image if the processor fails to authenticate the firmware image.

Optionally, the processor, after it has authenticated the firmware image, is configured to sign the hash file with a device signing key to generate a new signature section, and provide the new signature section to the memory controller.

Optionally, the memory controller is configured to encrypt the new signature section with the device key, and store the new signature section, after decryption, in the memory array.

Optionally, the device key is a symmetric key or an asymmetric key.

Optionally, the device is configured to undergo a secure boot process wherein the memory controller is configured to decrypt the firmware image using the device key after the firmware image has been encrypted using the device key by, for each of the plurality of firmware sections, retrieving the firmware section from the memory array, decrypting the firmware section using the device key, and provide the firmware section, after decryption by the device key, to the processor.

Optionally, the processor is configured to perform a hash function on each of the firmware sections after decryption by the device key, to generate a secure boot hashed section for each of the firmware sections after decryption by the device key, and generate a secure boot hash file by combining the secure boot hashed sections.

Optionally, the memory controller is configured to decrypt a new signing section, and provide the decrypted new signing section to the processor, and the processor is configured to authenticate the firmware image by verifying the decrypted new signing section using a public key, and comparing the decrypted new signing section with the secure boot hash file.

Optionally, the firmware image is received prior to its encryption by the memory controller, wirelessly or by a wired connection.

According to a second aspect of the disclosure there is provided a method of encrypting a firmware image comprising providing a processor, providing a memory controller, and encrypting, using the memory controller, the firmware image using a device key.

It will be appreciated that the method of the second aspect may include using and/or providing features set out in relation to the first aspect and may include other features as described herein.

According to a third aspect of the disclosure there is provided a computer-readable medium comprising instructions which, when executed by a computer, cause the computer to operate a memory controller to encrypt a firmware image using a device key.

Optionally, the firmware image comprises a plurality of firmware sections, and the computer-readable medium comprises instructions which, when executed by the computer, cause the computer to operate the memory control to encrypt the firmware image using the device key by, for each of the plurality of firmware sections, retrieving the firmware section, decrypting the firmware section using a shared key, encrypting the firmware section using the device key, and storing the firmware section as encrypted by the device key in a memory array.

Optionally, prior to encryption of the firmware image using the device key by the memory controller, the plurality of firmware sections are stored in the memory array, and the computer-readable medium comprises instructions which, when executed by the computer, cause the computer to operate the memory controller to encrypt the firmware image using the device key by, for each of the plurality of firmware sections, retrieving the firmware section from the memory array, decrypting the firmware section using the shared key, encrypting the firmware section using the device key, and storing the firmware section as encrypted by the device key in the memory array.

Optionally, the computer-readable medium comprises instructions which, when executed by the computer, cause the computer to operate the memory controller to, for each of the plurality of firmware sections, store the firmware section as encrypted by the device key in the memory array by overwriting the firmware section encrypted using the shared key as retrieved from the memory array.

Optionally, the computer-readable medium comprises instructions which, when executed by the computer, cause the computer to operate the processor to perform a hash function on each of the decrypted firmware sections to generate a hashed section for each of the decrypted firmware sections.

Optionally, for each of the decrypted firmware sections the computer-readable medium comprises instructions which, when executed by the computer, cause the computer to operate the processor to perform the hash function on the decrypted firmware section in parallel to the memory controller encrypting the firmware section using the device key and/or storing the firmware section as encrypted by the device key in the memory array.

It will be appreciated that the computer-readable medium of the third aspect may comprise instructions which, when executed by the computer, cause the computer to operate the processor and/or the memory controller to provide the functionality of any of the features of the first aspect and/or any of the embodiments of the processor and/or memory controller described herein, in accordance with the understanding of the skilled person.

### BRIEF DESCRIPTION OF THE DRAWINGS

The disclosure is described in further detail below by way of example and with reference to the accompanying drawings in which:

FIG. 1 is a schematic showing a process flow for a device undergoing a known conventional process of key replacement;

FIG. 2A is a schematic of a device in accordance with a first embodiment of the present disclosure, FIG. 2B is a schematic of a specific implementation of the device of FIG. 2A undergoing a first part of the firmware image encryption process, FIG. 2C is a schematic of the specific implementation of the device of FIG. 2A undergoing a second part of the firmware encryption process following on from the process shown in FIG. 2B, FIG. 2D is a schematic of a further specific implementation of the device of FIG. 2A undergoing a first part of the firmware image encryption process, FIG. 2E is a schematic of the further specific implementation of the device of FIG. 2A undergoing a second part of the firmware encryption process following on from the process shown in FIG. 2D, FIG. 2F is a schematic showing a process flow for the specific embodiment of the device of FIG. 2D and FIG. 2E undergoing the key replacement process;

FIG. 3A is a schematic showing a process flow for a specific embodiment of the device of FIG. 2D and FIG. 2E, in accordance with a second embodiment of the present disclosure, FIG. 3B is pseudo-code describing the process of flow of FIG. 3A;

FIG. 4A is a schematic showing a process flow for a specific embodiment of the device of FIG. 3A, in accordance with a third embodiment of the present disclosure, FIG. 4B is pseudo-code describing the process of flow of FIG. 4A; and

FIG. 5A is a flow chart of a method of encrypting a firmware image in accordance with a fourth embodiment of the present disclosure, FIG. 5B is a schematic of a computer-readable medium, in accordance with a fifth embodiment of the present disclosure.

### DETAILED DESCRIPTION

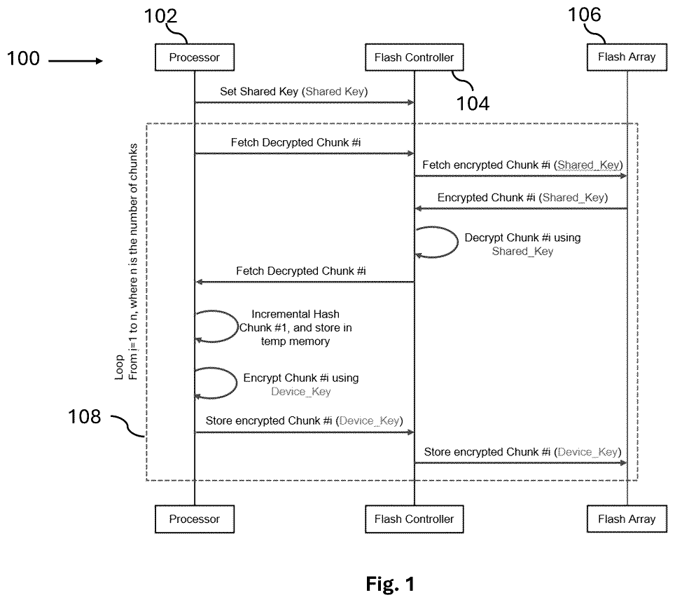

FIG. 1 is a schematic showing a process flow for a device 100 undergoing a known conventional process of key replacement during a FOTA process. In the present example the device 100 comprises a processor 102, a flash controller 104 and a flash array 106.

We assume that before the process of FIG. 1 begins, a new firmware image has been received and has been stored in the flash array 106. Conventionally, such images are broken down into multiple chunks or sections, with each chunk being encrypted using the same encryption key and a signing part that is used to verify the authenticity of the image. Thus, when all chunks have been received, the device 100 can decrypt them, check that they have not been tampered with and that they originate from a legitimate source/distributor and proceed with installing the new firmware image.

As can be observed in FIG. 1, the processor 102 provides a shared key to the flash controller 104 in a step labelled “Set Shared Key”. This step may take place before the new firmware image has been received.

Parenthesis is used in the step labels to denote the specific key being used in the step. For example, the shared key for (Shared_Key).

The device 100 then performs a loop 108 from i=1 to n iterations, where n is the integer number of chunks of the firmware image.

The processor 102 instructs the flash controller 104 to retrieve a decrypted first chunk from the flash array 106 in a step labelled “Fetch Decrypted Chunk #i”.

The decrypted first chunk may eventually be used by the processor 102 to calculate a hash, that will be used to verify a signature of the new firmware image, and thus authenticate the new firmware image. This verification process is not shown in FIG. 1, but would follow the completion of the loop 108.

The flash controller 104 retrieves from the flash array 106 the requested encrypted chunk (in steps labelled “Fetch encrypted Chunk #1” and “Encrypted Chunk #i”), and decrypts it using the shared key (in a step labelled “Decrypt Chunk #i using Shared_Key”) and provides it to the processor 102 (in a step labelled “Fetch Decrypted Chunk #i”)

The processor 102 then performs the following steps in a serial manner:
It calculates a hash of the plaintext chunk and stores it in a local memory (this local memory may be a cache or other similar type of memory, and may be referred to as a hash register or hash memory). This is undertaken in a step labelled “Incremental Hash Chunk #1, and store in temp memory”.
It re-encrypts the plaintext of the chunk with a unique key for this device. This device-unique or device-specific key (labelled Device_Key in FIG. 1) may be kept in a secure element integrated or securely accessible by the processor 102. This is undertaken in a step “Encrypt Chunk #i using Device_Key”.
It sends the re-encrypted chunk to the flash controller 104 for storing in the flash array 106. This is undertaken in a step labelled “Store encrypted Chunk #i”

Once the flash controller 104 stores the re-encrypted chunk to the flash array 106, the loop 108 continues for the next chunk, until all chunks have been processed in the above way. Thus, at the conclusion of the loop 108, the chunks that make up the new firmware image have all been re-encrypted with the device-specific key. If the device 100 is compromised and the device-specific key is obtained by a malicious actor, this would have no consequence to other devices, as the leaked device-specific key is of no use for any other device.

Conventional key replacement methods, such as is presented in FIG. 1, are resource intensive for the following reasons:
There is a need for increased memory that allows storing at least three images during the upgrade process (the firmware image that is currently in use, the firmware image that has been received and was encrypted by the distributor and the firmware image that was encrypted by the receiving device with the device-unique key).
The process takes a long time, as the receiving device 100 needs to sequentially perform the steps of decrypting the received image using the shared key, verify the signature of the received image, re-encrypt the image using the device-unique key and write the re-encrypted image to the flash array 106.

The above storage and memory requirements may be significant limitations for certain applications such as IoT or automotive applications. In the case of IoT applications the increased storage capacity needed for the conventional key replacement method may be unavailable or may raise the costs of the device. In automotive applications, there may be a desired to reduce the time needed to perform the firmware update to reduce the time that components of the vehicle or the vehicle itself is non-operating, or operating with reduced functionality.

Thus, there is a need for an improved method of firmware update that is robustly secure whilst improving on the aspects mentioned above. It is desirable to reduce the time and storage needed to perform a key-replacement process on a device undergoing a firmware update.

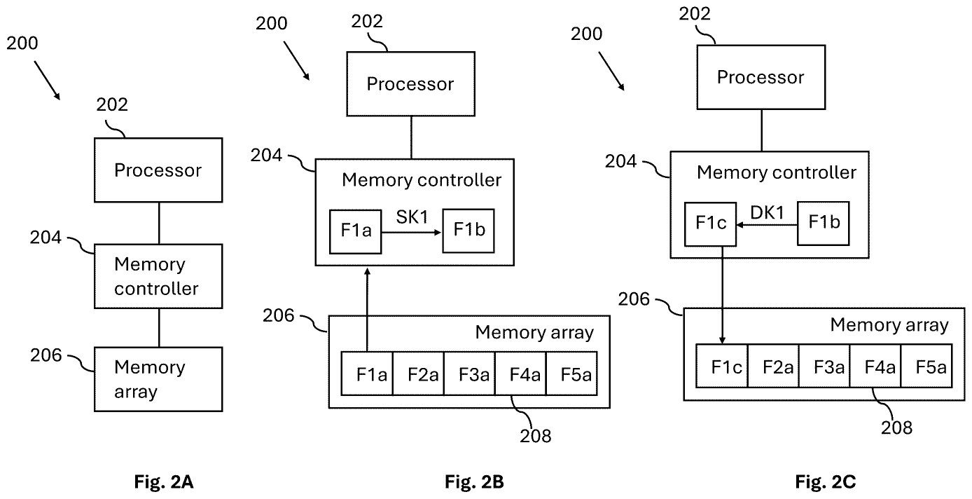

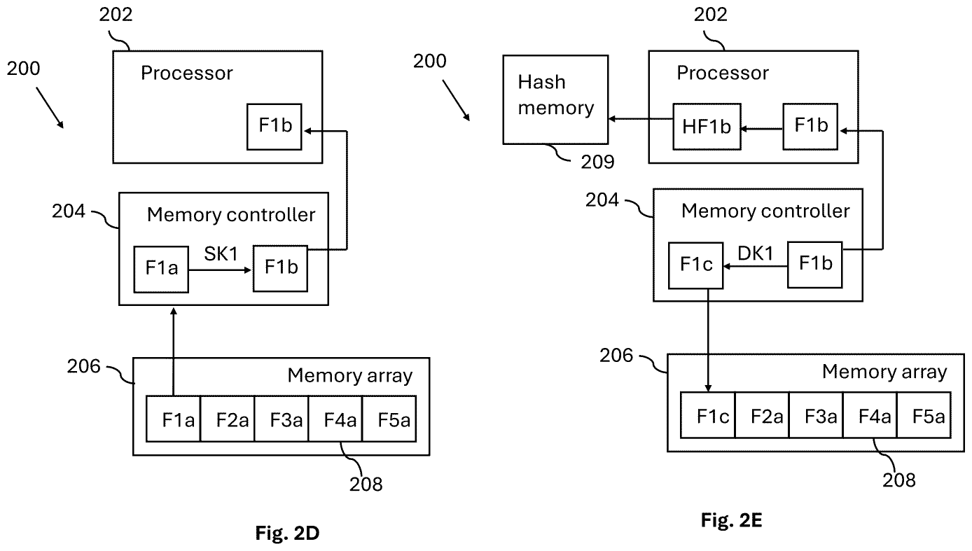

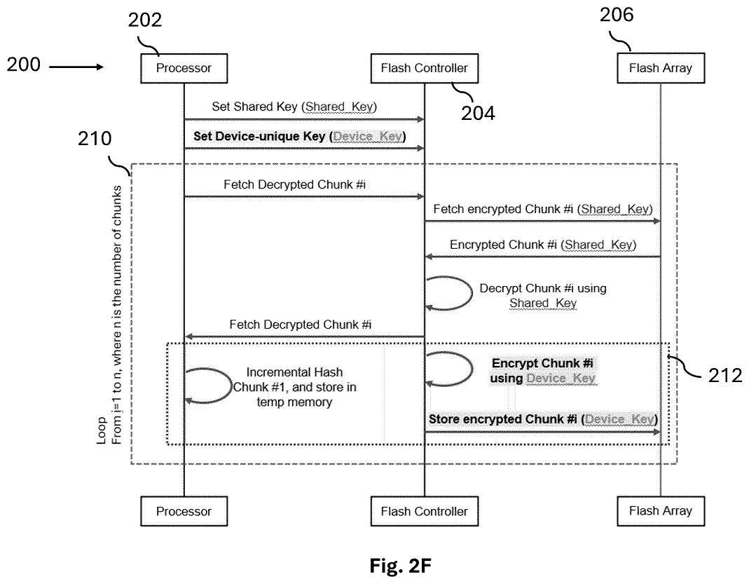

FIG. 2A is a schematic of a device 200 in accordance with a first embodiment of the present disclosure. The device 200 comprises a processor 202 and a memory controller 204 configured to encrypt a firmware image using a device key. During operation, the processor 202 may provide the device key to the memory controller 204.

The encryption with the device key may use a symmetric model or an asymmetric model. For example, for the symmetric model, the device key may be a symmetric key such as a shared key. For example, for the asymmetric model, the device key may be an asymmetric key such as a public key or a private key.

During operation, the firmware image may be stored in a memory array 206. The firmware image may have been received as part of an update process for the device 200. The firmware image may have been received over a wireless connection, for example as part of a FOTA process, or a wired connection.

It will be appreciated that the firmware image may be received as part of a FOTA process, however, in further embodiments, the firmware image may be received using another method in accordance with the understanding of the skilled person.

The memory array 206 may be external to the device 200 or may be part of the device 200. The memory controller 204 may be a flash controller and the memory array 206 may be a flash array. During operation, the memory controller 204 may read and/or write data to the memory array 206.

In further embodiments, the memory array 206 may be random access memory (RAM), or a temporary memory that temporarily stores data that was wirelessly received.

The device 200 may be a single apparatus including both the processor 202 and the memory controller 204, for example, where the device 200 is an IoT end device. The memory array 206 may be implemented as part of the single apparatus that constitutes the device 200 or may be an external component that is coupled to the device via a wired or wireless connection.

In a further embodiment the processor 202 and the memory controller 204 may be part of separate apparatuses that collectively form the device 200. During operation the processor 202 and the memory controller 204 may exchange information. The processor 202 and the memory controller 204 may be configured to communicate via a wired or wireless connection.

The memory controller 204 may be fitted with an encryption engine. An encryption engine allows the data stored in the memory array 206, for example a flash array, to be stored in an encrypted state. Once the processor 202 needs to access the encrypted data, the memory controller 204 retrieves the encrypted data, decrypts it and forwards the decrypted data to the processor 202. This type of mechanism may be used in a Secure Boot process that allows a device to boot up using a locally-stored encrypted firmware image, thus ensuring that at the completion of Secure Boot the device is at a non-compromised state.

The cryptographic functions provided by the device 200 may be implemented by a variety of different algorithms as will be clear to a skilled person in the field of cybersecurity.

FIG. 2B is a schematic of a specific implementation of the device 200 of FIG. 2A undergoing a first part of the firmware image encryption process. In the present example, a firmware image 208 is stored in the memory array 206. The firmware image 208 comprises a plurality of firmware sections F1a, F1b, F1c, F1d, F1e, which may be referred to as “chunks”.

The memory controller 204 is configured to encrypt the firmware image 208 using a device key by applying the encryption process to each of the firmware sections F1a-F1e in a sequence.

As shown in FIG. 2B, during operation, the memory controller 204 retrieves the firmware section F1a from the memory array 206 and then decrypts the firmware section F1a using a shared key SK1 to provide an unencrypted firmware section F1b.

The processor 202 may provide the shared key SK1 to the memory controller 204.

FIG. 2C is a schematic of the specific implementation of the device 200 of FIG. 2A undergoing a second part of the firmware encryption process following on from the process shown in FIG. 2B.

As shown in FIG. 2C, during operation, the memory controller 204 encrypts the firmware section F1b using the device key DK1 to provide a decrypted firmware section F1c. The memory controller 204 then stores the newly decrypted firmware section F1c in the memory array 206. The memory controller 204 may be configured to overwrite the initial firmware section F1a encrypted by the shared key SK1 with the firmware section F1c as encrypted using the device key DK1.

The sequence of operation of the memory controller 204 described in relation to FIG. 2B followed by FIG. 2C is then repeated until all firmware sections F1a-F5a have been encrypted using the device key DK1.

At the end of the process described in relation to FIG. 2B and FIG. 2C a key replacement procedure has been completed, where the shared key SK1 initially used to encrypt the firmware image 208 has been replaced by the device key DK1.

FIG. 2D is a schematic of a further specific implementation of the device 200 of FIG. 2A undergoing a first part of the firmware image encryption process. FIG. 2E is a schematic of the further specific implementation of the device 200 of FIG. 2A undergoing a second part of the firmware encryption process following on from the process shown in FIG. 2D.

In the present example, and in addition to the procedure described in relation to the embodiment presented in FIGS. 2B and 2C, the processor 202 is further configured to perform a hash function on each of the decrypted firmware sections F1b-F5b to generate a hashed section for each of the decrypted firmware sections. The hashed sections may be stored in a hash memory element 209. The hash memory element 209 may be a temporary or local memory.

A hash function is a mathematical function used to convert a decrypted firmware section to a string of characters with a fixed length, thereby generating the hashed sections.

As shown in FIG. 2D, during operation, the processor 202 requests the decrypted firmware section F1b from the memory controller 204. The processor 202 then receives the decrypted firmware section F1b from the memory controller 204. As shown in FIG. 2E, during operation, the processor 202 performs the hash function to the decrypted firmware section F1b to generate the hashed section HF1b. The processor 202 may then store the hashed section HF1b in the hash memory element 209.

The sequence of operation of the processor 202 in applying the hash function as described in relation to FIG. 2D followed by FIG. 2E is then repeated until all decrypted firmware sections F1b-F5b have been subjected to the hash function to generated the hashed sections. The result of the hash process provided by the processor 202 may be a hash file comprising the hash sections combined into a single file, which may be stored in the hash memory element 209.

The processor 202 may be perform the hash function on each of the decrypted firmware sections in parallel to the memory controller 204 encrypting the same decrypted firmware section using the device key DK1 and/or storing the firmware section as encrypted by the device key DK1 in the memory array 206.

For example, and with reference to FIG. 2E, whilst the processor 202 is applying the hash function to generate the hashed section HF1b, the memory controller 204 may simultaneously be encrypting the firmware section F1b to generate the firmware section F1c and/or storing the firmware section F1c in the memory array 206.

FIG. 2F is a schematic showing a process flow for the specific embodiment of the device 200 of FIG. 2D and FIG. 2E undergoing the key replacement process for the firmware image 208. In the present example, the firmware image 208 comprises n firmware sections, where n is an integer greater than one.

The process flow of the present embodiment shares features with the process as described in relation to the conventional process of FIG. 1, with common steps sharing the same labelling and functioning substantially as described in relation to FIG. 1.

In the present example the device 200 performs a loop 210 from i=1 to n iterations, where n is the integer number of chunks of the firmware image 208.

In the present example, the memory controller 204 is a flash controller and the memory array 206 is a flash array. However, it will be appreciated that in further embodiments the process of FIG. 2F may be applied with other types of memory controller and memory array.

As can be seen in FIG. 2F, further to the processor 202 providing to the memory controller 204 the shared key to enable the memory controller 204 to decrypt the received firmware sections, the processor 202 also provides the device key to the memory controller 204 in the step labelled “Set Device-unique Key”. The firmware sections are referred to as “chunks” in the schematic.

Thus, the memory controller 204 can perform an additional function when compared to the memory controller 104 of FIG. 1. In the present embodiment the memory controller 204 can decrypt the encrypted firmware sections stored in the memory array 206, and also encrypt data for storage in the memory array 206. This is indicated by the memory controller 204 performing the steps labelled “Encrypt Chunk #1 using Device_Key” and “Store encrypted Chunk #i (Device_Key).

Advantageously, this additional functionality can take place in parallel to the processor's 202 hashing functionality. Thus, the steps that were previously performed sequentially by the processor 100 of FIG. 1, can now be performed in parallel. The substantially simultaneous functions that take place at the processor 200 and the memory controller 204 are labelled using reference numeral 212.

As can be seen in FIG. 2F, once the memory controller 204 provides the decrypted firmware section to the processor 202 (in the step labelled “Fetch Decrypted Chunk #i”), the memory controller 204 performs the key replacement function by encrypting the firmware section with the previously obtained device key. This is then stored in the memory array 204, without any further input being needed from the processor 202.

By using the memory controller 204 to encrypt data rather than only decrypt as is the case in FIG. 1, the time needed for the loop 210 to be completed is substantially reduced when compared to the loop 108 of FIG. 1, thereby resulting in an improvement over known systems.

In summary, embodiments of the present disclosure enable functions that would normally be done in sequence by the same controller (e.g. the device's main processor, such as the processor 102 of FIG. 1) are done in parallel by a plurality of controllers (e.g. the device's main processor, being the processor 202, and the memory controller 204). In embodiments of the present disclosure the memory controller 204 (that traditionally is used only to decrypt data stored on the memory and to forward the decrypted data to the processor, as provided by the flash controller 104 of FIG. 1) performs the additional step of re-encrypting the data with device-unique key.

The memory controller 204 may be configured to store the re-encrypted firmware section in the same location in the memory array 206 from where the memory controller 204 obtained the originally encrypted firmware section. In other words, the memory controller 204 may overwrite the original firmware section with the key replaced firmware section, for example as described in relation to FIG. 2C. In this manner, there is no need for the memory array 206 to be able to accommodate both the received firmware image sections and the re-encrypted firmware image sections. In this way, the storage requirements of the process are reduced when compared to known systems, since there is no need to maintain both the received chunk and the re-encrypted chunk. This overwriting feature results in a further improvement over known systems.

In the embodiments shown in FIG. 2A-2F, the firmware image 208 is initially stored in the memory array 206 prior to the key replacement process. It will be appreciated that in a further embodiment, the key replacement process may be performed during reception of the firmware, i.e. while downloading the firmware image from a FOTA server. For example, and with reference to FIG. 2B, the memory controller 204 may retrieve each of the firmware sections F1a-F5a as they are being received by the device 200 during an update procedure, rather than retrieving them from the memory array 208, and then proceed with the key replacement process as previously described.

Such an embodiment ensures that the whole of the firmware is never locally stored, thereby further improving the security of the device 200 whilst reducing the need for additional storage. This provided an additional advantage for memory-constrained devices.

In summary, embodiments of the present disclosure provide an optimized key replacement process for a received firmware image on an edge device.

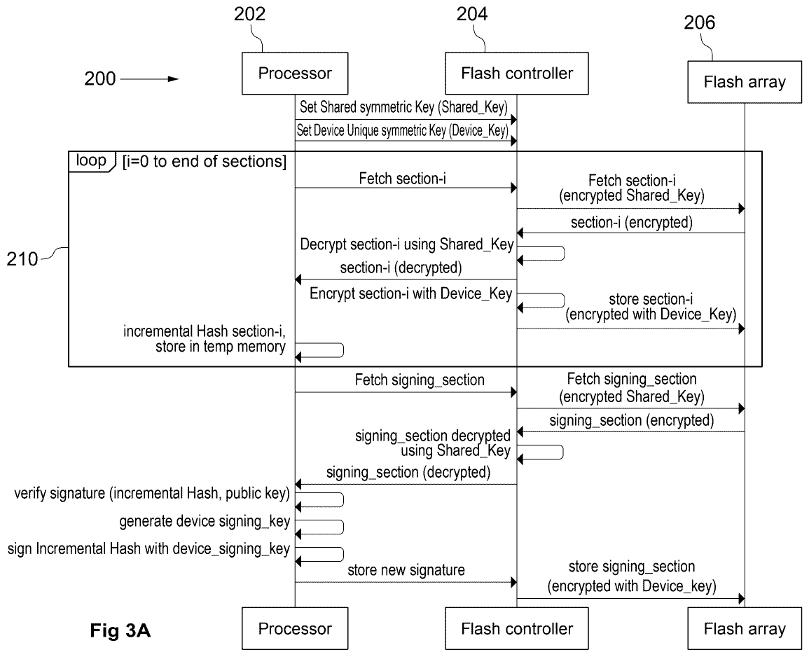

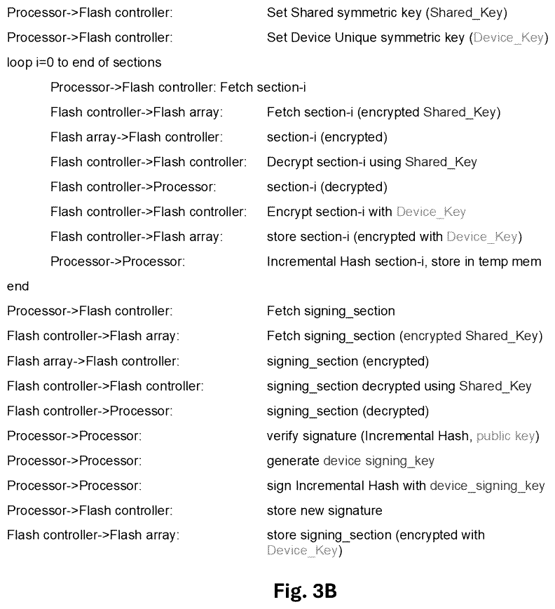

FIG. 3A is a schematic showing a process flow for a specific embodiment of the device 200 of FIG. 2D and FIG. 2E, in accordance with a second embodiment of the present disclosure. In the process flow of the present embodiment, the device 200 undergoes the key replacement process as described for FIG. 2F, followed by an authentication process.

The steps of the key replacement process in the present schematic have been relabelled as follows when compared to FIG. 2F:
“Set Shared symmetric key (Shared_Key)” corresponds to “Set Shared Key (Shared_Key)”.
“Set Device Unique symmetric key (Device_Key)” corresponds to “Set Device-unique Key (Device_Key)”.
“Fetch section-l” corresponds to “Fetch Decrypted Chunk #i”.
“Fetch section-l (encrypted Shared_Key)” corresponds to “Fetch encrypted Chunk #i (Shared_Key)”.
“section-l (encrypted)” corresponds to “Encrypted Chunk #i (Shared_Key)”
“Decrypt section-l using Shared_Key” corresponds to “Decrypt Chunk #i using Shared_Key”
“section-l (decrypted)” corresponds to “Fetch Decrypted Chunk #i”.
“Encrypt section-l with Device_Key” corresponds to “Encrypt Chunk #i using Device_Key”.
“store section-l (encrypted with Device_Key)” corresponds to “Store encrypted Chunk #i (Device_Key)”.
“Incremental Hash section-l, store in temp memory” corresponds to “Incremental Hash Chunk #1, and store in temp memory”.

FIG. 3A extends the process of FIG. 2F to the steps after the loop 210 is completed. Once the loop 210 is complete, all the hash sections that were calculated by the processor 202 will be stored in the hash memory element 209 in an incremental manner to form the hash file. Additionally, once the loop 210 is completed, all firmware sections will have been stored in the memory array 206 and encrypted using the device key DK1.

Storing the hash sections in an incremental manner means that each hash sections may be combined with the previously stored hash section (for example appended to the previously stored hash) to create a new hash value that is based on the contents of all processed firmware sections thus far, thereby providing the hash file.

FIG. 3A shows a complete firmware update process, for example a FOTA process that includes signature verification and both for the data and the signature of the received firmware image. At the completion of the process described in FIG. 3A, the received firmware image has undergone key replacement for all its parts that were previously encrypted using the shared key.

After the loop 210 is completed, a similar process is implemented with respect to the signature of the received firmware image.

During operation, the processor 202 requests that the memory controller 204 obtains a signing section, as shown by the step labelled “Fetch signing_section”. In response the memory controller 204 retrieves the signing section as originally received OTA, i.e. encrypted with the shared key. The memory controller 204 then decrypts the signing section and provides the decrypted signature to the processor 202.

In the present embodiment, the memory controller 204 requests the signing section from the memory array 206, as shown by the step labelled “Fetch signing_section (encrypted Shared_Key)” and the memory array 206 provides the signing section to the memory controller 204, as shown by the step labelled “signing_section (encrypted)”.

In the present embodiment, the memory controller 204 is configured to decrypt the signing section which is illustrated by the step labelled “signing_section decrypted using Shared_Key”. The memory controller 204 is further configured to provide the decrypted signing section to the processor 202, as shown by the step labelled “signing_section (decrypted)”.

The processor 202 is configured to authenticate the firmware image by verifying the decrypted signing section using a public key, and comparing the decrypted signing section with the hash file, as shown by the step labelled “verify signature (incremental Hash, public key)”.

In the present embodiment, the processor 202 is configured to discard the firmware image if the processor 202 fails to authenticate the firmware image. After the processor 202 has authenticated the firmware image, the processor 202 is configured to sign the hash file with a device signing key to generate a new signature section, as shown by steps “generate device signing_key” and “sign Incremental Hash with device_signing_key”. The processor 202 is further configured to provide the new signature section to the memory controller 204, as shown by the step “store new signature”.

The memory controller 204 may then encrypt the new signature section with the device key and store the new signature section, after decryption, in the memory array 206, as shown by the step labelled “store signing_section (encrypted with Device_Key)”.

The encryption of the new signature section with the device key may use a symmetric model or an asymmetric model. For example, for the symmetric model, the device key may be a symmetric key such as a shared key. For example, for the asymmetric model, the device key may be an asymmetric key such as a public key or a private key.

Signing with a symmetric key per device can assist in a post quantum resistance case.

In summary, the processor 202 verifies the signature using a public key and compares the signature with the hash values in the hash register 209. If the signature is not verified, then the received firmware image may be discarded, along with all the processed firmware sections. Once the signature is verified, the device 202 generates or recovers a device signing key, and uses it to sign the incremental hash. The device signing key can be symmetrical or asymmetrical (public/private) depending on the cryptographic capabilities or configuration of the device 200. This new signature is then passed to the memory controller 204, which encrypts it with the device key before storing it in the memory array 206.

FIG. 3B is pseudo-code describing the process of flow of FIG. 3A.

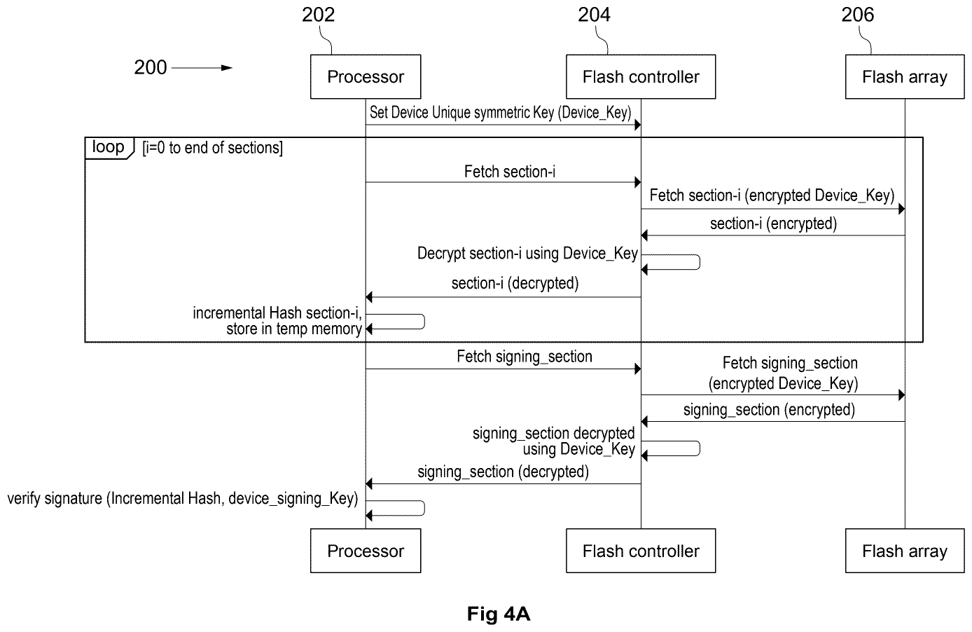

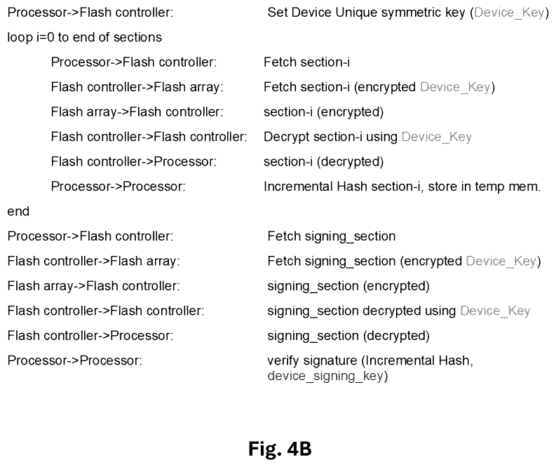

FIG. 4A is a schematic showing a process flow for a specific embodiment of the device 200 of FIG. 3A, in accordance with a third embodiment of the present disclosure. The process flow of the present embodiment shows a secure boot process that may be applied after a key replacement and authentication process, and may be used with any of the device 200 embodiments described herein, in accordance with the understanding of the skilled person. In the present embodiment, the secure boot process follows the conventional approach, but instead of using the shared key to access the contents of the memory array 206, the device key is used.

The device 200 is configured to undergo a secure boot process in which the memory controller 204 is configured to decrypt the firmware image using the device key after the key replacement procedures. During operation, and for each of the firmware sections, the memory controller retrieves the firmware section from the memory array 206 (in the steps labelled “Fetch section-l (encrypted Device_Key)” and “section-l (encrypted)”; decrypts the firmware section using the device key (in the step labelled “Decrypt section-l using Device_Key”); and provides the firmware section, after decryption by the device key, to the processor 202 (in the step labelled “section-l (decrypted)”.

The processor 202 may perform a hash function on each of the firmware sections after decryption by the device key, to generate a secure boot hashed section for each of the firmware sections after decryption by the device key, and generate a secure boot hash file by combining the secure boot hashed sections (in the step labelled “Incremental Hash section-l, store in temp memory”).

The memory controller 204 may be configured to decrypt a new signing section (as shown by the step labelled “signing_section decrypted using Device_Key”); and provide the decrypted new signing section to the processor 202 (as shown by the step labelled “signing section (decrypted)”. The processor 202 may be configured to authenticate the firmware image by verifying the decrypted new signing section using a public key, and comparing the decrypted new signing section with the secure boot hash file (as shown by the step “verify signature (Incremental Hash, device_signing_key)”.

FIG. 4b is pseudo-code describing the process of flow of FIG. 4a.

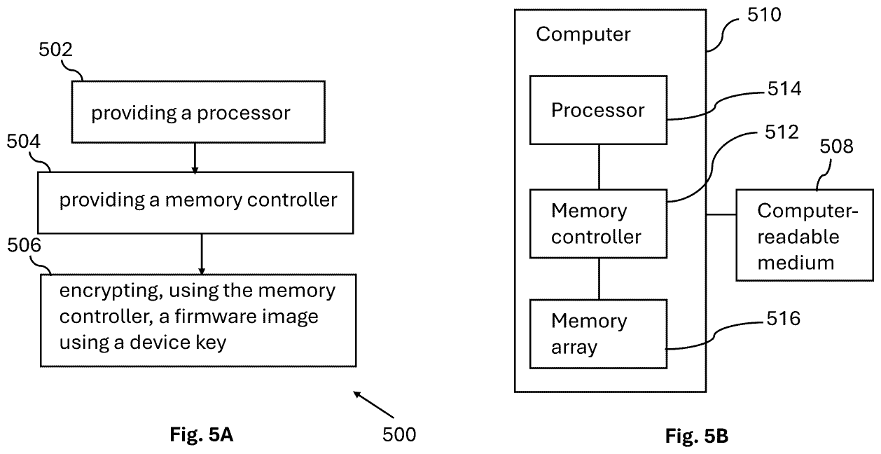

FIG. 5A is a flow chart of a method 500 of encrypting a firmware image in accordance with a fourth embodiment of the present disclosure. The method 500 comprises providing a processor at a step 502, providing a memory controller at a step 504 and encrypting, using the memory controller, the firmware image using a device key at a step 506.

Further embodiments of the method 500 may include using and/or providing any of the features described in relation to the embodiments of the present disclosure. For example, further embodiments of the method 500 may include performing the steps of the key replacement process as described in relation to FIG. 2F, the authentication process described in relation to FIG. 3A and/or the secure boot process described in relation to FIG. 4A.

FIG. 5B is a schematic of a computer-readable medium 508, in accordance with a fifth embodiment of the present disclosure. The computer-readable medium 508 comprises instructions which, when executed by a computer 510, cause the computer 510 to operate a memory controller 512 to encrypt a firmware image using a device key.

In the present example, the computer 510 comprises the memory controller 512, the processor 514 and a memory array 516.

In further embodiments, the memory controller 512 may be implemented as described for any of the memory controller 204 embodiments described herein; and/or the processor 514 may be implemented as described for any of the processor 202 embodiments described herein; and/or the memory array 516 may be implemented as described for any of the memory array 206 embodiments described herein, in accordance with the understanding of the skilled person.

In specific embodiments, the computer-readable medium 508 may comprise instructions to enable the computer 510 to function as the device 200 of any of the embodiments described herein, in accordance with the understanding of the skilled person.

In further embodiments, the computer 510 may be separate from the device 200, such that the computer-readable medium 508 comprises instructions to enable the computer 510 to control the device 200 to function as described for any of the embodiments of the present disclosure, in accordance with the understanding of the skilled person

The computer-readable medium 508 may comprise instructions to enable the computer 510 provide the key replacement process as described in relation to FIG. 2F, the authentication process described in relation to FIG. 3A and/or the secure boot process described in relation to FIG. 4A.

Various improvements and modifications may be made to the above without departing from the scope of the disclosure.

1. A device comprising:
a processor; and
a memory controller configured to encrypt a firmware image using a device key.

2. The device of claim 1, wherein the processor is configured to provide the device key to the memory controller.

3. The device of claim 1, wherein:
the firmware image comprises a plurality of firmware sections; and
the memory controller is configured to encrypt the firmware image using the device key by:
for each of the plurality of firmware sections:
retrieving the firmware section;
decrypting the firmware section using a shared key;
encrypting the firmware section using the device key; and
storing the firmware section as encrypted by the device key in a memory array.

4. The device of claim 3, wherein:
prior to encryption of the firmware image using the device key by the memory controller, the plurality of firmware sections are stored in the memory array; and
the memory controller is configured to encrypt the firmware image using the device key by:
for each of the plurality of firmware sections:
retrieving the firmware section from the memory array;
decrypting the firmware section using the shared key;
encrypting the firmware section using the device key; and
storing the firmware section as encrypted by the device key in the memory array.

5. The device of claim 4, wherein the memory controller is configured to, for each of the plurality of firmware sections, store the firmware section as encrypted by the device key in the memory array by overwriting the firmware section encrypted using the shared key as retrieved from the memory array.

6. The device of claim 3, wherein the processor is configured to provide the shared key to the memory controller.

7. The device of claim 3, wherein the processor is configured to perform a hash function on each of the decrypted firmware sections to generate a hashed section for each of the decrypted firmware sections.

8. The device of claim 7, wherein, for each of the decrypted firmware sections:
the processor is configured to perform the hash function on the decrypted firmware section in parallel to the memory controller encrypting the firmware section using the device key and/or storing the firmware section as encrypted by the device key in the memory array.

9. The device of claim 7, wherein the processor is configured to perform the hash function on each of the decrypted firmware sections by:
for each of the decrypted firmware sections:
requesting the decrypted firmware section from the memory controller;
receiving the decrypted firmware section from the memory controller; and
performing the hash function on the decrypted firmware section, as received.

10. The device of claim 7, wherein the processor is configured to store the hashed sections in a hash memory element.

11. The device of claim 7, wherein the processor is configured to generate a hash file by combining the hashed sections.

12. The device of claim 11, wherein:
the memory controller is configured to:
decrypt a signing section; and
provide the decrypted signing section to the processor; and
the processor is configured to authenticate the firmware image by:
verifying the decrypted signing section using a public key; and
comparing the decrypted signing section with the hash file.

13. The device of claim 12, wherein the memory controller is configured to decrypt the signing section and provide the decrypted signing section to the processor, in response to a request from the processor.

14. The device of claim 12, configured to discard the firmware image if the processor fails to authenticate the firmware image.

15. The device of claim 12, wherein the processor, after it has authenticated the firmware image, is configured to:
sign the hash file with a device signing key to generate a new signature section; and
provide the new signature section to the memory controller.

16. The device of claim 15, wherein the memory controller is configured to:
encrypt the new signature section with the device key; and
store the new signature section, after decryption, in the memory array.

17. The device of claim 16, wherein the device key is a symmetric key or an asymmetric key.

18. The device of claim 3, wherein the device is configured to undergo a secure boot process, wherein:
the memory controller is configured to decrypt the firmware image using the device key after the firmware image has been encrypted using the device key by:
for each of the plurality of firmware sections:
retrieving the firmware section from the memory array;
decrypting the firmware section using the device key; and
provide the firmware section, after decryption by the device key, to the processor.

19. The device of claim 18, wherein the processor is configured to:
perform a hash function on each of the firmware sections after decryption by the device key, to generate a secure boot hashed section for each of the firmware sections after decryption by the device key; and
generate a secure boot hash file by combining the secure boot hashed sections.

20. The device of claim 19, wherein:
the memory controller is configured to:
decrypt a new signing section; and
provide the decrypted new signing section to the processor; and
the processor is configured to authenticate the firmware image by:
verifying the decrypted new signing section using a public key; and
comparing the decrypted new signing section with the secure boot hash file.

21. The device of claim 1, wherein the firmware image is received prior to its encryption by the memory controller, wirelessly or by a wired connection.

22. A method of encrypting a firmware image, the method comprising:
providing a processor;
providing a memory controller; and
encrypting, using the memory controller, the firmware image using a device key.

23. A computer-readable medium comprising instructions which, when executed by a computer, cause the computer to operate a memory controller to encrypt a firmware image using a device key.
